(19) United States
(12) Patent Application Publication
(10) Pub. No.: US 2017/0184290 A1
(43) Pub. Date: Jun. 29, 2017

(54) TRACK SYSTEM

(71) Applicant: DAVINCI OPTO CORP., NEW TAIPEI CITY (TW)

(72) Inventor: Hua-Jung Chiu, New Taipei City (TW)

(21) Appl. No.: 14/981,967

(22) Filed: Dec. 29, 2015

(51) Int. Cl. F21V 21/35; F21V 21/18

(52) U.S. Cl. CPC F21V 21/35; F21V 21/18

(57) ABSTRACT

A track system includes a track. The track includes a track body, a first rail structure and a second rail structure. The track body has an inner surface and an outer surface opposite to the inner surface. The first rail structure is formed on the inner surface of the track body. The second rail structure is formed on the outer surface of the track body.

### BACKGROUND OF THE INVENTION

1. Field of the Invention

The present invention relates to a track system, and more specifically, to a track system having inner and outer rails of a track.

2. Description of the Prior Art

In general, a conventional track system adopts the design that an adapter of a lighting device could be slidably inserted into a track mounted on a supporting surface (e.g. a ceiling or a wall) to make the lighting device slidable along the track so that the positioning of the lighting device can be adjusted as desired. However, since the aforesaid design usually requires the adapter to be inserted into the track laterally from one side end of the track, it would cause a user much inconvenience in inserting the adapter into the track, so as to influence the operational convenience of the track system.

### SUMMARY OF THE INVENTION

The present invention provides a track system including a track. The track includes a track body, a first rail structure, and a second rail structure. The track body has an inner surface and an outer surface opposite to the inner surface. The first rail structure is formed on the inner surface of the track body. The second rail structure is formed on the outer surface of the track body.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a track system according to an embodiment of the present invention.

FIG. 2 is an exploded diagram of a track and an illumination device in FIG. 1.

FIG. 3 is a sectional diagram of a telescopic positioning mechanism along a sectional line A-A in FIG. 2.

FIG. 4 is an enlarged diagram of a lifting mechanism in FIG. 1.

FIG. 5 is an exploded diagram of the track in FIG. 2, a joint and a conductive track.

FIG. 6 is an exploded diagram of the track in FIG. 2, the joint and the conductive track according to another embodiment of the present invention.

FIG. 7 is an exploded diagram of the track in FIG. 2, the joint and the conductive track according to another embodiment of the present invention.

FIG. 8 is an exploded diagram of the track and a joint in FIG. 1.

FIG. 9 is an assembly diagram of an illumination device according to another embodiment of the present invention.

FIG. 10 is an enlarged diagram of an illumination unit in FIG. 9.

FIG. 11 is a diagram of the illumination unit in FIG. 9 being pivoted to a changeable gear box.

FIG. 12 is a diagram of an adapter in FIG. 9 being connected to a second connection surface of the changeable gear box.

FIG. 13 is an exploded diagram of the track and a joint according to another embodiment of the present invention.

FIG. 14 is a sectional diagram of the joint in FIG. 13 along a sectional line B-B.

FIG. 15 is an enlarged diagram of a lifting mechanism according to another embodiment of the present invention.

FIG. 16 is a sectional diagram of a roller device in FIG. 15 along a sectional line C-C.

FIG. 17 is a sectional diagram of balls being separate from a cable in FIG. 16.

### DETAILED DESCRIPTION

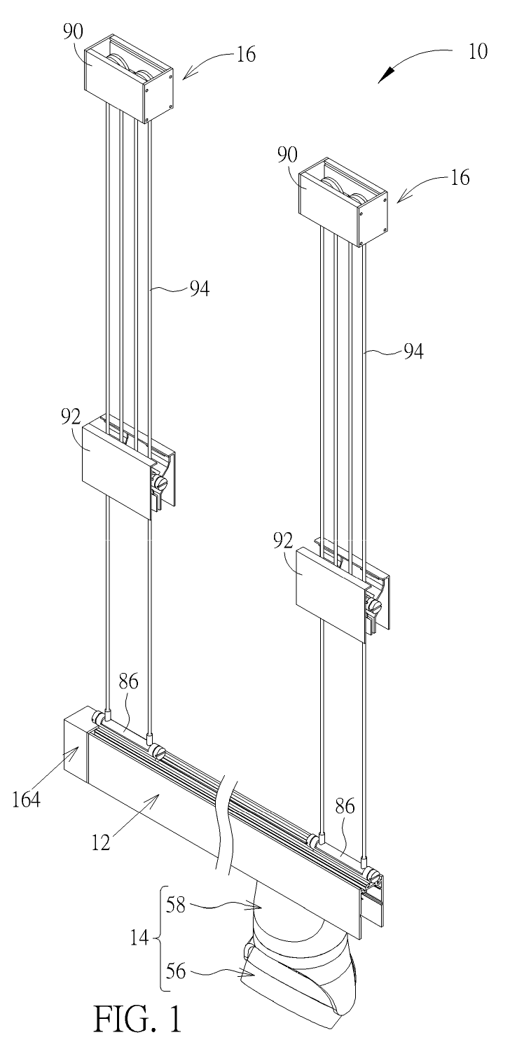

Please refer to FIG. 1, which is a diagram of a track system 10 according to an embodiment of the present invention. The track system 10 could be preferably a low-voltage track lighting device, but not limited thereto. As shown in FIG. 1, the track system 10 includes a track 12, an illumination device 14, and a lifting mechanism 16.

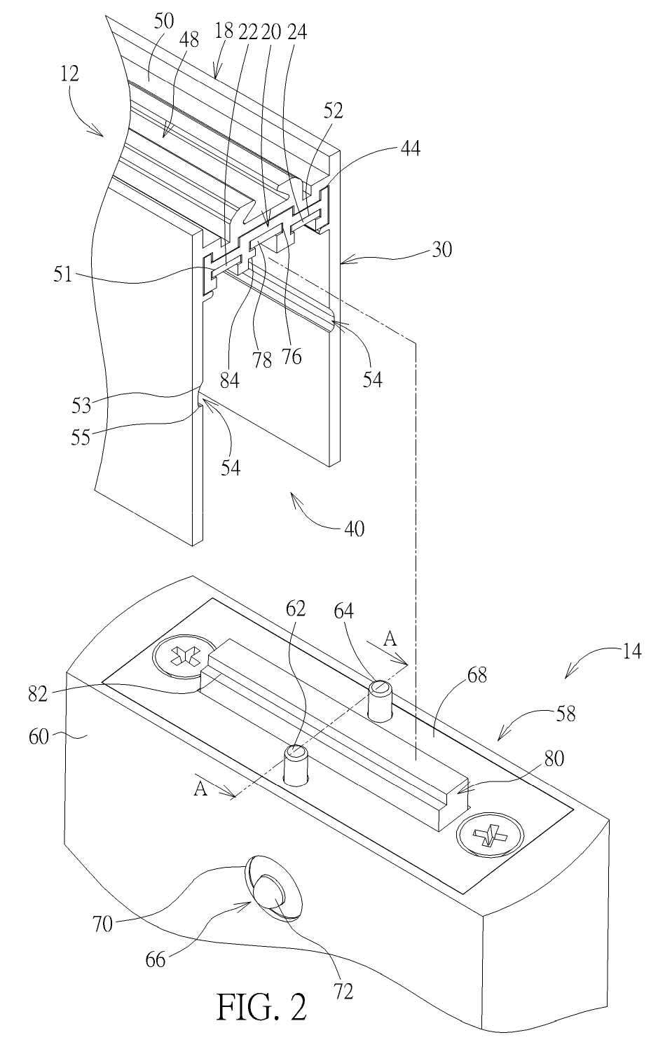

The track 12 could be channel-shaped. To be more specific, as shown in FIG. 2, which is an exploded diagram of the track 12 and the illumination device 14 in FIG. 1, the track 12 includes a track body 18, a first rail structure 40, and a second rail structure 48. The track body 18 has an inner surface 44 and an outer surface 50 opposite to the inner surface 44. The first rail structure 40 is formed on the inner surface 44, and the second rail structure 48 is formed on the outer surface 50. To be more specific, in this embodiment, the track 12 further includes an insulation sheet 20 and two electrode sheets 22, 24. The insulation sheet 20 could be preferably made of plastic material (but not limited thereto) and is inserted into the first rail structure 40. The insulation sheet 20 has two third rail structures 51, 52 formed spaced, and the two electrode sheets 22, 24 (i.e. a positive electrode and a negative electrode) are inserted into the two third rail structures 51, 52 respectively so as to efficiently prevent the short-circuit problem.

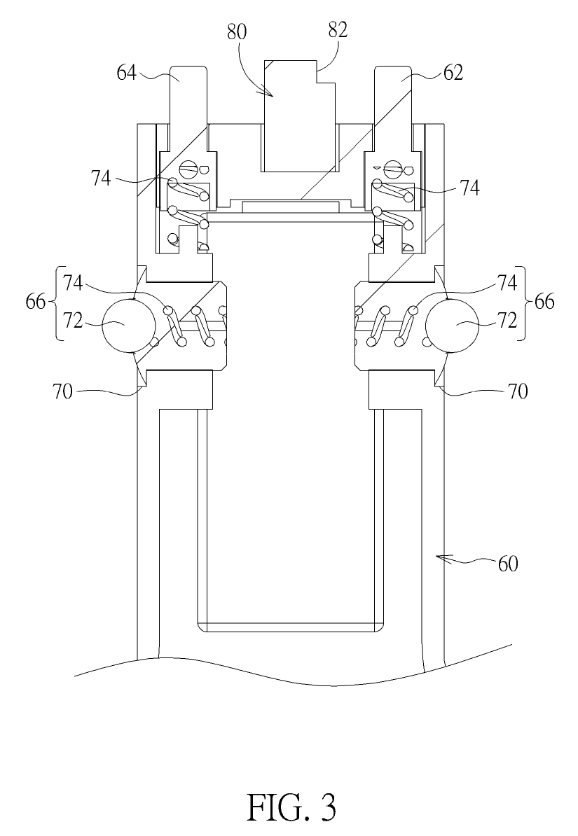

The illumination device 14 is slidably mounted into the first rail structure 40 to electrically contact with the two electrode sheets 22, 24 for establishing electrical connection between the illumination device 14 and the track 12 via the two electrode sheets 22, 24. More detailed description for the illumination device 14 is provided as follows. Please refer to FIG. 2 and FIG. 3. FIG. 3 is a sectional diagram of a telescopic positioning mechanism 66 along a sectional line A-A in FIG. 2. As shown in FIG. 2, the first rail structure 40 has at least one positioning recess 54 (two shown in FIG. 2, but not limited thereto), and a curvature of a first recessed portion 53 of the positioning recess 54 close to the second rail structure 48 could be preferably less than a curvature of a second recessed portion 55 of the positioning recess 54 away from the second rail structure 48 so that the telescopic positioning mechanism 66 could be engaged with the positioning recess 54 more steadily. In this embodiment, the illumination device 14 could include an illumination unit 56 and an adapter 58, and the adapter 58 could include an adapter body 60, two conductive pillars 62, 64, and at least one telescopic positioning mechanism 66 (two telescopic positioning mechanisms 66 disposed on two sides of the adapter body 60 respectively in this embodiment, but only one shown in FIG. 2 due to the viewing angle). The illumination unit 56 could be a lighting device commonly applied to a track lighting apparatus, such as an LED (Light Emitting Diode) lamp as shown in FIG. 1 (but not limited thereto). The illumination unit 56 is disposed under and electrically connected to the adapter 58, so that the illumination unit 56 could be powered to emit light when the illumination unit 56 is mounted on the track 12 via the adapter 58. The two conductive pillars 62, 64 are disposed on a top surface 68 of the adapter body 60 corresponding to the two electrode sheets 22, 24.

As shown in FIG. 2 and FIG. 3, the telescopic positioning mechanism 66 includes a ball 72 and an elastic member 74 (e.g. a spring), and a groove 70 is formed on the side of the adapter body 60 corresponding to the telescopic positioning mechanism 66. The ball 72 is disposed in the groove 70. The elastic member 74 abuts against the ball 72 and the groove 70 for driving the ball 72 to be engaged with the positioning recess 54 so as to detachably fix the adapter 56 to the track 12. In practical application, as shown in FIG. 3, the present invention could further utilize the two elastic members 74 to abut against the two conductive pillars 62, 64 respectively for driving the two conductive pillars 62, 64 to contact with the two electrode sheets 22, 24 surely.

Via the aforesaid design, when the user wants to mount the illumination device 14 on the track 12, the user just needs to align the adapter 58 with the first rail structure 40 from one side end or the bottom of the track 12, and then insert the adapter 58 into the first rail structure 40. During the aforesaid process, the two conductive pillars 62, 64 could electrically contact with the two electrode sheets 22, 24 for establishing electrical connection between the illumination device 14 and the track 12 via the adapter 58, and the ball 72 could be engaged with the positioning recess 54 for detachably fixing the adapter 58 in the first rail structure 40. Accordingly, the user could complete the mounting process of the track system 10 conveniently and quickly. In such a manner, the present invention could solve the prior art problem that the adapter needs to be inserted into the track laterally from one side end of the track to cause the user much inconvenience, so as to allow that the user could insert the illumination device 14 into the track 12 from one side end or the bottom of the track 12 as desired. Thus, the operational convenience of the track system 10 could be greatly improved.

Furthermore, as shown in FIG. 2, a magnetic sheet 78 is inserted into the first rail structure 40 and is located between the two electrode sheets 22, 24. In practical application, the insulation sheet 26 could further have a fourth rail structure 76 located between the two third rail structures 51, 52. The magnetic sheet 78 could be inserted into the fourth rail structure 76, and a magnetic block 80 is disposed on the top surface 68 of the adapter body 60. Accordingly, when the adapter body 60 is inserted into the first rail structure 40, the magnetic block 80 could magnetically contact with the magnetic sheet 78 so as to magnetically attract the adapter body 60 to be detachably attached to the track 12. A first step structure 82 is formed on the magnetic block 80, and a second step structure 84 is formed in the first rail structure 40. In this embodiment, the second step structure 84 is formed on the fourth rail structure 76 for matching with the first step structure 82 to guide the magnetic block 80 to magnetically contact with the magnetic sheet 78, so as to generate the foolproof effect.

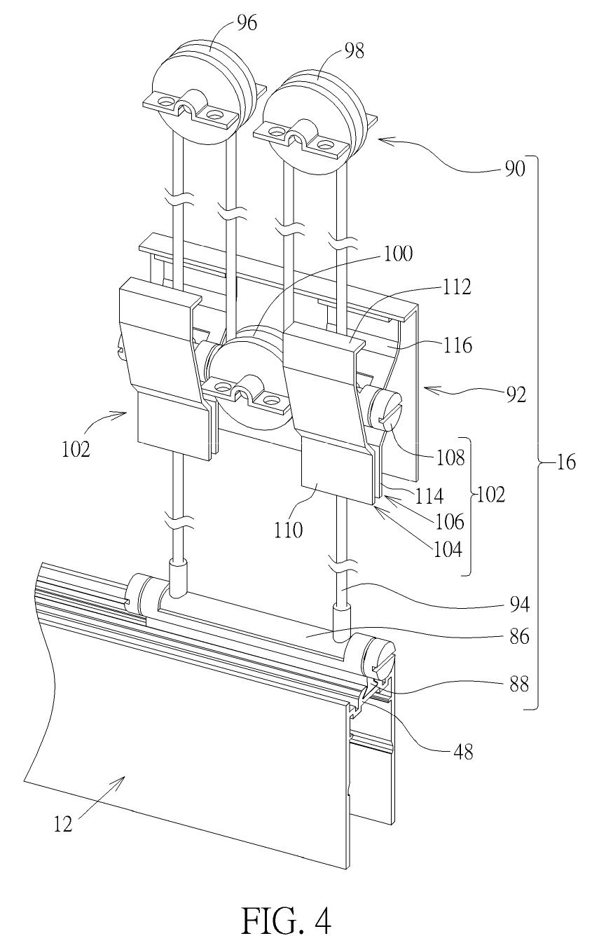

As for the mechanical design of the lifting mechanism 16, it is described in detail as follows. Please refer to FIG. 4, which is an enlarged diagram of the lifting mechanism 16 in FIG. 1. For clearly showing the internal mechanical design of the lifting mechanism 16, the housings of the lifting mechanism 16 are omitted in FIG. 4. In this embodiment, as shown in FIG. 4, the lifting mechanism 16 includes a pivot shaft 86, a connection strip 88, a roller device 90, a lifting device 92, and a cable 94. The connection strip 88 is connected to the pivot shaft 86 and inserted into the second rail structure 48 to make the track 12 rotatable relative to the pivot shaft 86, so that the light emitting angle of the illumination device 14 could be adjusted via the pivot shaft 86 and the illumination device 14 could be positioned horizontally via rotation of the pivot shaft 86. The roller device 90 is fixedly disposed above the track 12 (e.g. by fixing the roller device 90 to a ceiling or a wall), and has a first roller 96 and a second roller 98 adjacent to the first roller 96. The lifting device 92 is disposed between the track 12 and the roller device 90 and has a third roller 100. The cable 94 is wound on the first roller 96, the third roller 100 and the second roller 98 sequentially and is connected to the two ends of the pivot shaft 86, so as to make the lifting device 92 slidable along the cable 94. In such a manner, the height of the track 12 could be adjusted via sliding of the lifting device 92 along the cable 94 between the track 12 and the roller device 90.

To be noted, in practical application, the lifting device 92 could further have at least one cable clip 102 (two shown in FIG. 4, but not limited thereto) disposed on the cable 94. As shown in FIG. 4, the cable clip 102 includes a first clip 104, a second clip 106, and a torsional spring 108. The first clip arm 104 has a first clamping portion 110 and a first releasing portion 112, and a second clip arm 106 has a second clamping portion 114 and a second releasing portion 116. A torsional spring 108 is connected between the first clip arm 104 and the second clip arm 106 for driving the first clamping portion 110 and the second clamping portion 114 to clamp the cable 94 cooperatively. Accordingly, the lifting device 92 could be positioned at any position on the cable 94 as desired by clamping of the cable clip 102, so that the user could adjust the height of the track 12 more conveniently.

On the other hand, when the user wants to move the lifting device 92 for performing height adjustment of the track 12, the user just needs to press the first releasing portion 112 and the second releasing portion 116 toward each other, so as to make the first clamping portion 110 and the second clamping portion 114 separate from the cable 94. In such a manner, since the cable 94 is no longer clamped by the cable clip 102, the lifting device 92 could be slidable along the cable 94, so as to allow the user to move the lifting device 92 to any position along the cable 94 as desired for conveniently adjusting the height of the track 12.

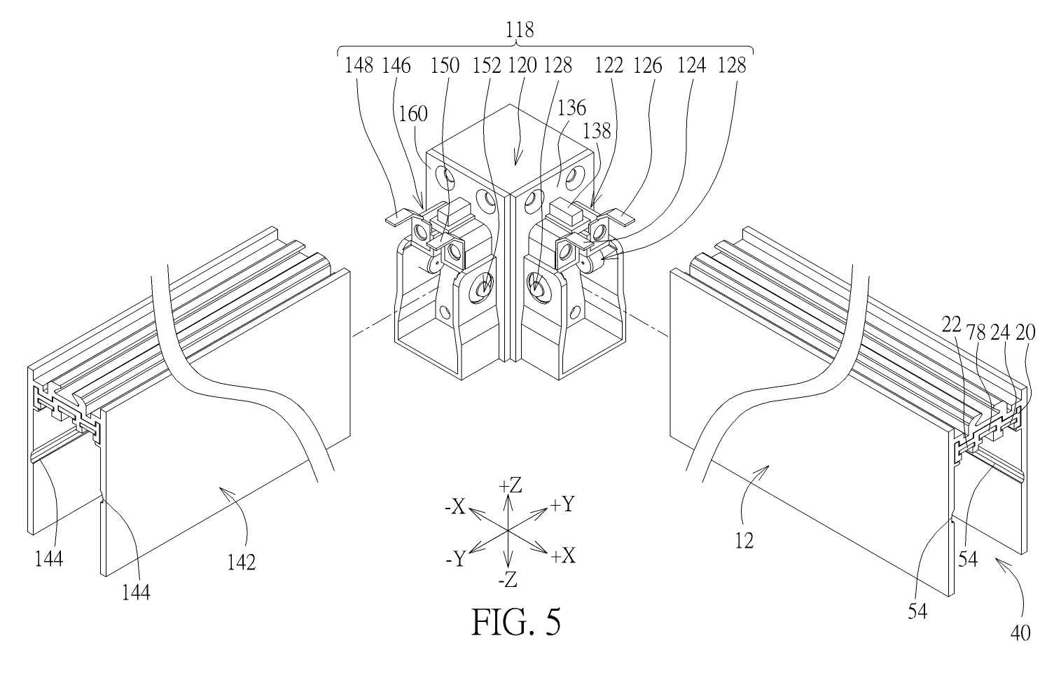

Furthermore, the present invention could utilize a joint to connect the track 12 to another track. For example, please refer to FIG. 5, which is an exploded diagram of the track 12 in FIG. 2, a joint 118 and a conductive track 142. As shown in FIG. 5, the joint 118 could include a joint body 120, a connector 122, two first conductive sheets 124, 126 and at least one telescopic positioning mechanism 128 (two shown in FIG. 5, but not limited thereto). The connector 122 is detachably connected to a first surface 136 of the joint body 120. The two first conductive sheets 124, 126 are disposed on the connector 122 and are electrically connected to the joint body 120. The two telescopic positioning mechanisms 128 are disposed on the two sides of the connector 122 respectively. In this embodiment, the telescopic positioning mechanism 128 could have the same mechanical design with the telescopic positioning mechanism 66 for engaging with the positioning recess 54 to detachably fix the joint 118 in the first rail structure 40, and the related description could be reasoned by analogy according to the aforesaid description for the mechanical design of the telescopic positioning mechanism 66. Similarly, in this embodiment, a magnetic block 138 could be disposed on the connector 122 for magnetically contacting with the magnetic sheet 78 so as to detachably attach the connector 122 to the track 12.

Moreover, as shown in FIG. 5, a conductive track 142 could have the same structural design with the track 12 and have at least one positioning recess 144 formed therein (two shown in FIG. 5, but not limited thereto), and the joint 118 could further include a connector 146, two second conductive sheets 148, 150 and a telescopic positioning mechanism 152 (two shown in FIG. 5, but not limited thereto). The connector 146 is detachably connected to a second surface 160 of the joint body 120. The two second conductive sheets 148, 150 are disposed on the connector 146 and electrically connected to the joint body 120. In this embodiment, the telescopic positioning mechanism 152 could have the same mechanical design with the telescopic positioning mechanism 66 for engaging with the positioning recess 144 to detachably fix the joint 118 to the conductive track 142, and the related description could be reasoned by analogy according to the aforesaid description for the mechanical design of the telescopic positioning mechanism 66.

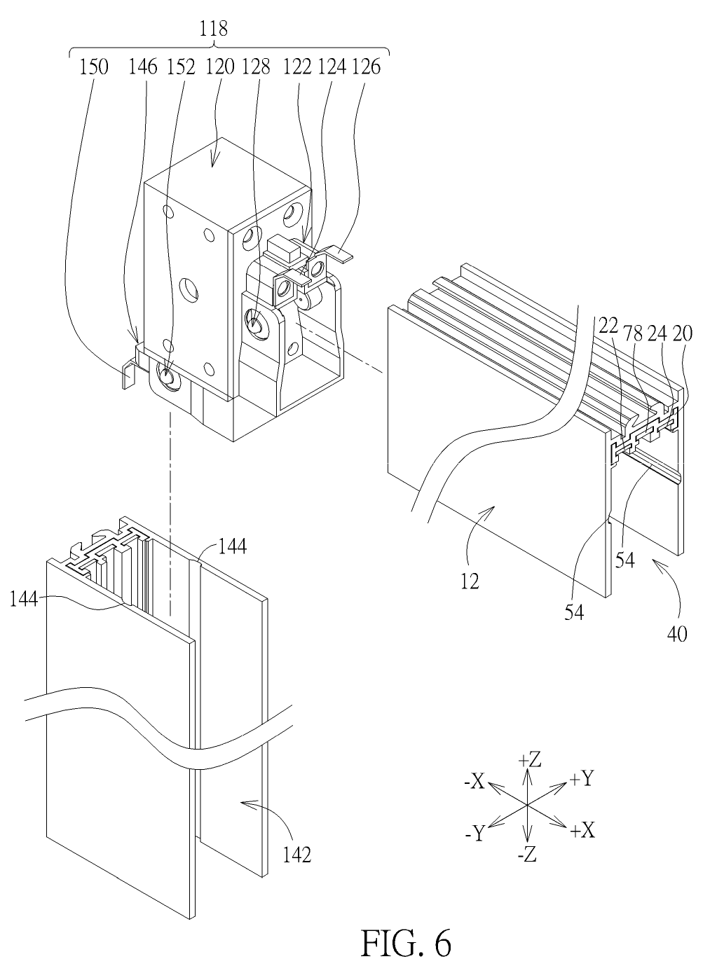

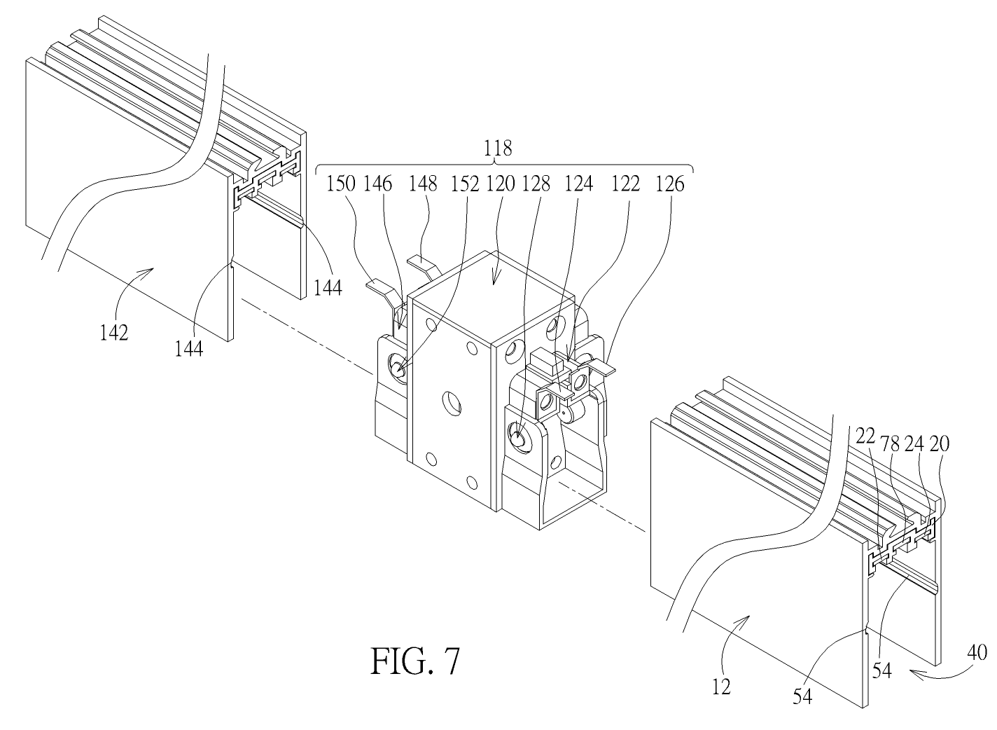

Via the aforesaid design, after the track 12 is connected to the joint 118 via the connector 122 and the conductive track 142 is connected to the joint 118 via the connector 146 for establishing electrical connection of the track 12 with the joint 118 and the conductive track 142, the illumination device 14 could be slidable on an L-shaped track structure on a horizontal surface (i.e. a XY plane in FIG. 5) cooperatively formed by assembly of the track 12, the joint 118, and the conductive track 142. To be noted, the joint design for connecting at least two tracks is not limited to FIG. 5. That is to say, since the connector is detachably connected to the joint body, the present invention could utilize the aforesaid joint design to form other track structures of different shapes, such as an inverted L-shaped track structure on a vertical surface (i.e. a XZ plane in FIG. 6) as shown in FIG. 6 or a straight track structure as shown in FIG. 7. As for the related description for other derived embodiments (e.g. a cross-shaped track structure), it could be reasoned by analogy according to the aforesaid embodiment and omitted herein.

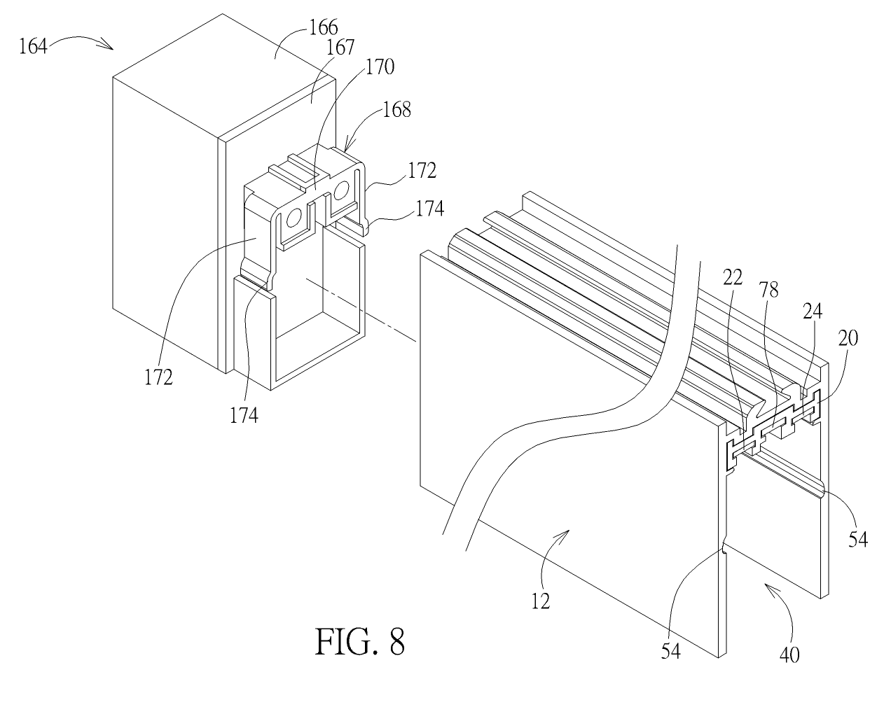

Furthermore, please refer to FIG. 8, which is an exploded diagram of the track 12 and a joint 164 in FIG. 1. As shown in FIG. 1 and FIG. 8, the track 12 could further include the joint 164. The joint 164 could include a joint body 166 and the connector 168. The connector 168 is detachably connected to a surface 167 of the joint body 166 for engaging with the positioning recess 54. In this embodiment, the connector 168 could have at least one side elastic arm 172 (two shown in FIG. 8, but not limited thereto), and the side elastic arm 172 has a protruding engaging end portion 174. Accordingly, when the connector 168 is inserted into the first rail structure 40, the protruding engaging end portion 174 is engaged with the positioning recess 54 to detachably fix the joint 164 to one side end of the track 12, for protection and preventing the illumination device 14 accidentally falling off from one side end of the track 12.

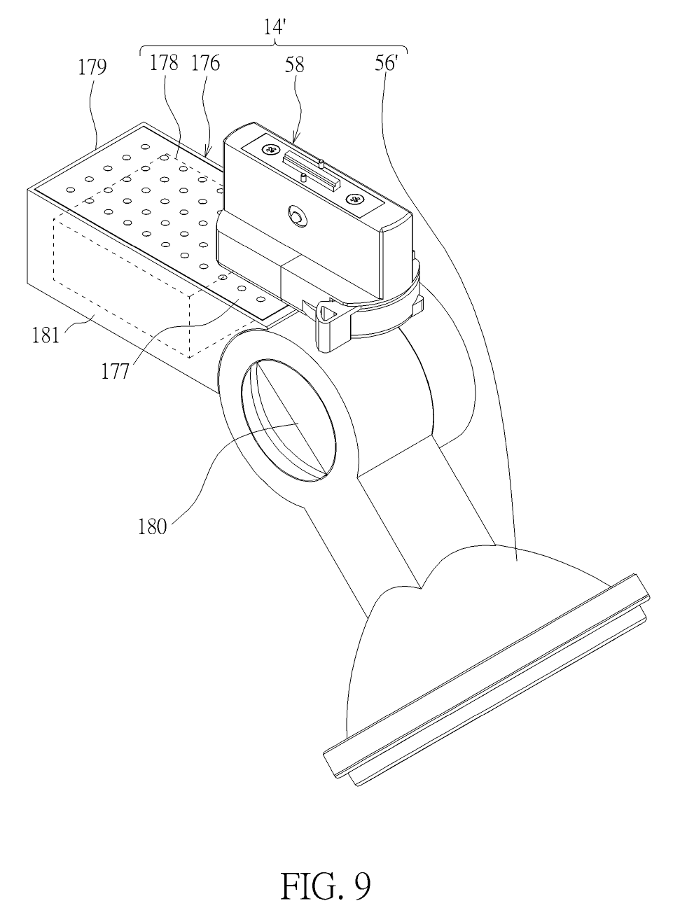

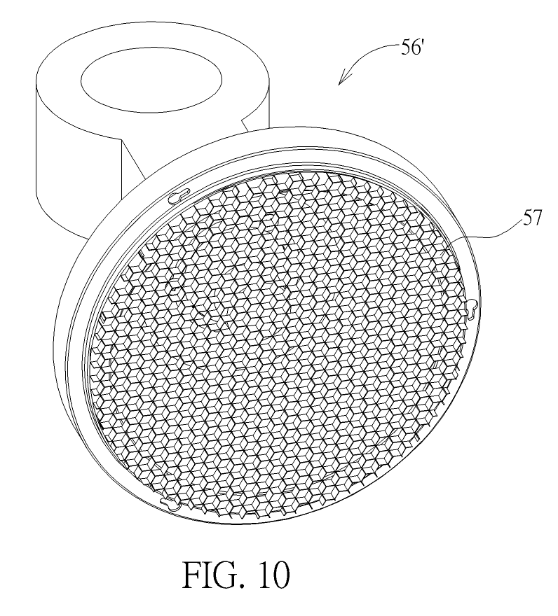

Moreover, the design of the illumination device is not limited to the aforesaid embodiment. For example, please refer to FIG. 9, which is an assembly diagram of an illumination device 14′ according to another embodiment of the present invention. Components both mentioned in this embodiment and the aforesaid embodiments represent components with similar structures or functions, and the related description is omitted herein. As shown in FIG. 9, the illumination device 14′ could include the adapter 58, an illumination unit 56′, a changeable gear box 176 and a driver 178, wherein the driver 178 is briefly depicted by dotted lines in FIG. 9. The illumination unit 56′ could be a lighting device commonly applied to a track light apparatus, such as an LED lamp. In practical application, as shown in FIG. 10, which is an enlarged diagram of the illumination unit 56′ in FIG. 9, the illumination unit 56′ could have a honeycomb lens cover 57 detachably disposed thereon for generating the anti-glare effect.

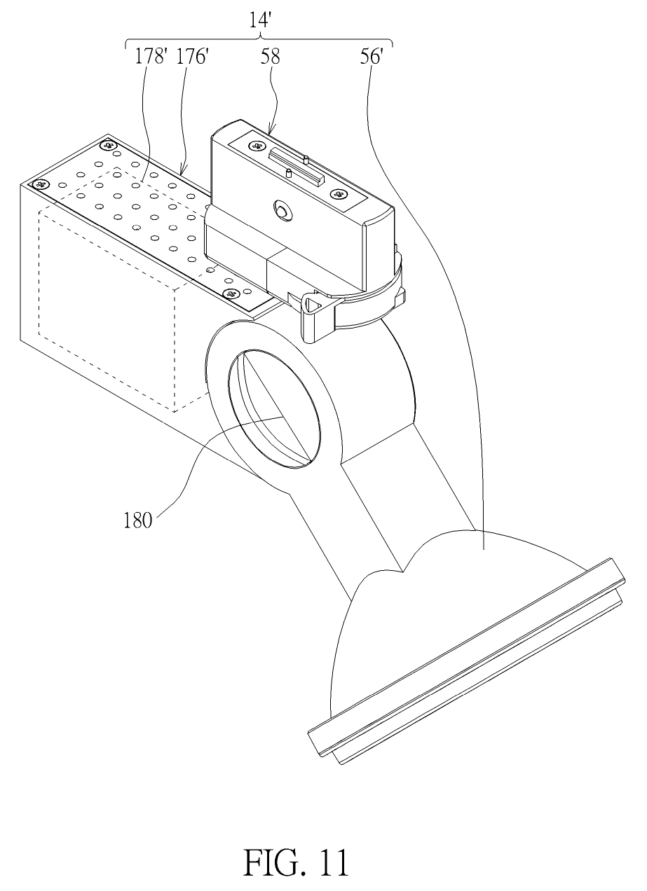

In this embodiment, the illumination unit 56′ could be detachably pivoted to the changeable gear box 176 via a removable knob 180, so that the user could adjust the light emitting angle of the illumination unit 56′. The changeable gear box 176 is detachably connected to the adapter 58, and the driver 178 is disposed in the changeable gear box 176 and is electrically connected to the adapter 58 for controlling the illumination unit 56′ to emit light. Via the aforesaid design, since the illumination unit 56′ could be detached from the changeable gear box 176, the illumination device 14′ could be suitable for different types of gear boxes. For example, please refer to FIG. 9 and FIG. 11. FIG. 11 is a diagram of the illumination unit 56′ in FIG. 9 being pivoted to a changeable gear box 176′. If the user wants to replace the driver 178 with the driver 178′, the user just needs to remove the removable knob 180 to detach the changeable gear box 176 from the illumination unit 56′. Subsequently, the user could utilize the removable knob 180 to screw the illumination unit 56′ on the changeable gear box 176′ suitable for the driver 178′ (as shown in FIG. 11), so as to complete the driver replacing process.

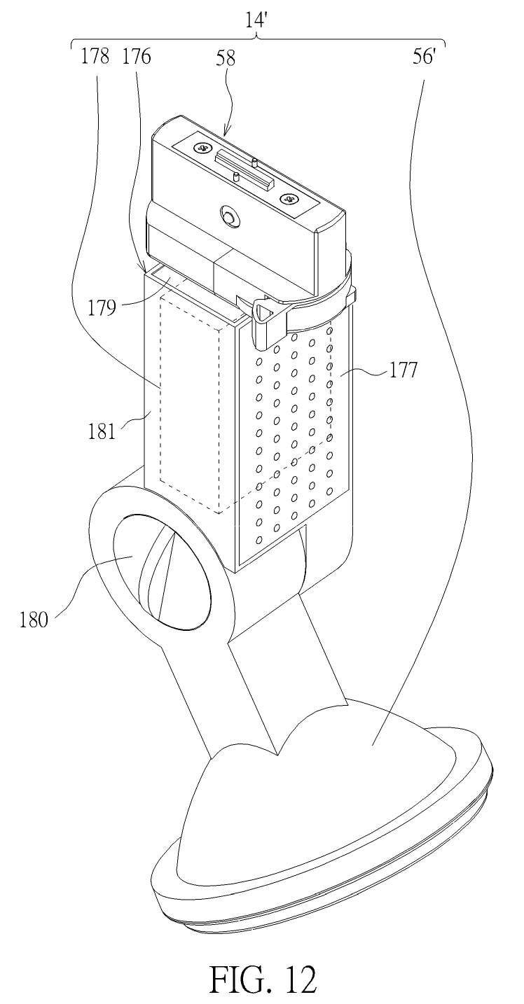

Furthermore, as shown in FIG. 9, the adapter 58 is detachably connected to a first connection surface 177 of the changeable gear box 176 adjacent to the illumination unit 56′, but not limited thereto. For example, the changeable gear box 176 could have a second connection surface 179 away from the illumination unit 56′, and the adapter 58 could also be detachably connected to the second connection surface 179 (as shown in FIG. 12). As for the related description for other derived embodiments (e.g. the adapter 58 could be selectively connected to a first connection surface 181, which has a smaller connection area relative to the first connection surface 177 as shown in FIG. 9, of the changeable gearbox 176 adjacent to the illumination unit 56′), it could be reasoned by analogy according to the aforesaid description and omitted herein.

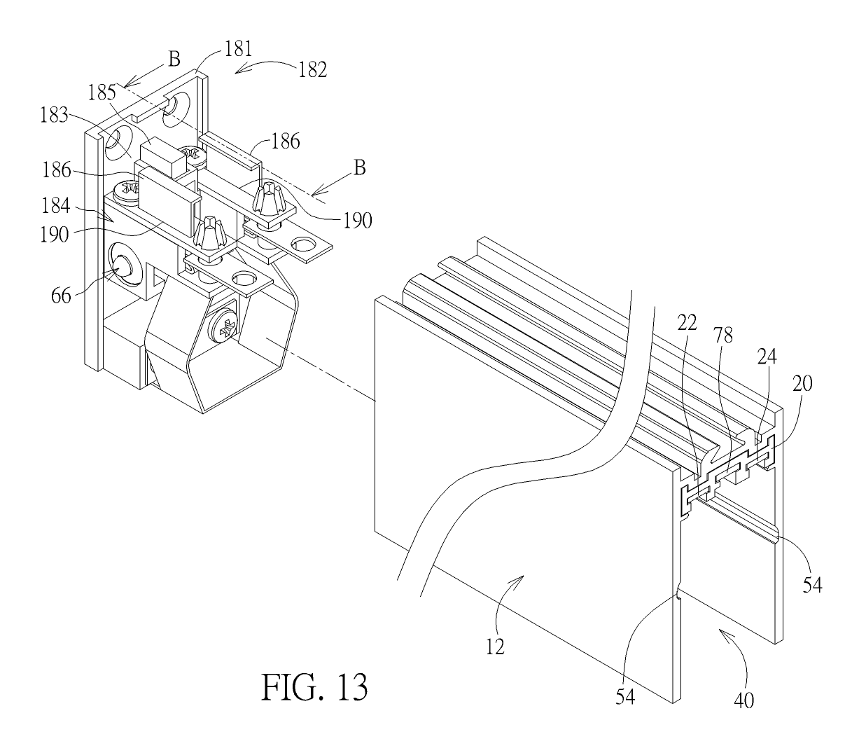

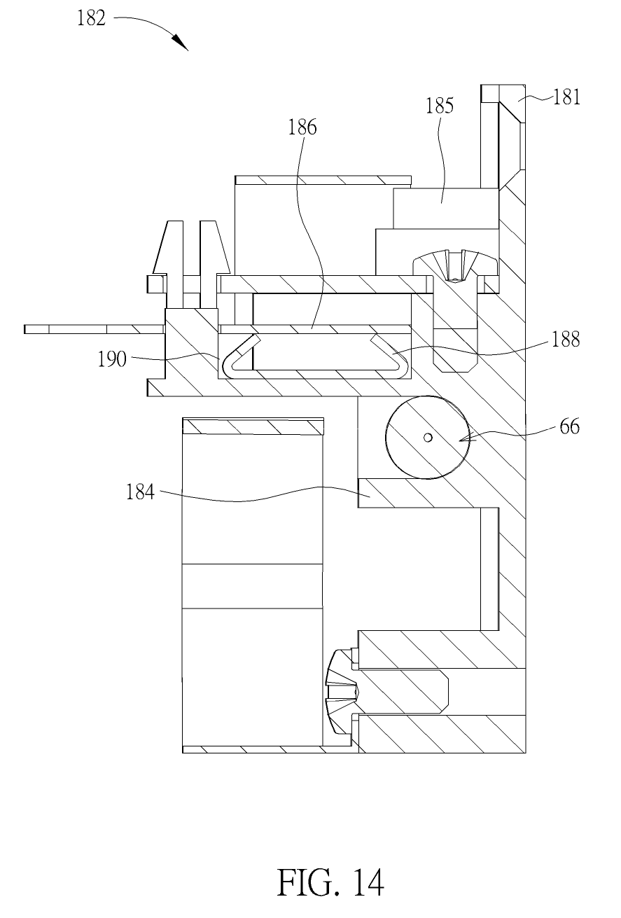

It should be mentioned that the design of the joint is not limited to the aforesaid embodiment. Please refer to FIG. 13 and FIG. 14. FIG. 13 is an exploded diagram of the track 12 and a joint 182 according to another embodiment of the present invention. FIG. 14 is a sectional diagram of the joint 182 in FIG. 13 along a sectional line B-B. Components both mentioned in this embodiment and the aforesaid embodiments represent components with similar structures or functions, and the related description is omitted herein. As shown in FIG. 13 and FIG. 14, the track 12 could further include the joint 182. The joint 182 could include a joint body 181, a connector 184, two conductive sheets 186, and two elastic members 188. The connector 184 is detachably connected to a surface 183 of the joint body 181. The connector 184 has two grooves 190. The two conductive sheets 186 are inserted into the two grooves 190 respectively. The two elastic members 188 are disposed in the two grooves 190 respectively and abut against the two conductive sheets 186 respectively. In this embodiment, the elastic member 188 could be preferably a bending elastic sheet (as shown in FIG. 14), but not limited thereto, meaning that the elastic member 188 could be other type of elastic component, such as a spring. Via the aforesaid design, when the connector 184 is inserted into the first rail structure 40, the two elastic members 188 could drive the two conductive sheets 186 to electrically contact with the two electrode sheets 22, 24 for establishing electrical connection between the joint 182 and the track 12 via the two electrode sheets 22, 24. Furthermore, in this embodiment, the joint 182 could further include at least one telescopic positioning mechanism 66 (two telescopic positioning mechanisms 66 disposed on two sides of the connector 184 respectively in this embodiment, but only one shown in FIG. 13 due to the viewing angle), and the telescopic positioning mechanism 66 is engaged with the positioning recess 54 to detachably fix the joint 182 to one side end of the track 12. Similarly, in this embodiment, a magnetic block 185 could be disposed on the connector 184 for magnetically contacting with the magnetic sheet 78 so as to detachably attach the joint 182 to the track 12.

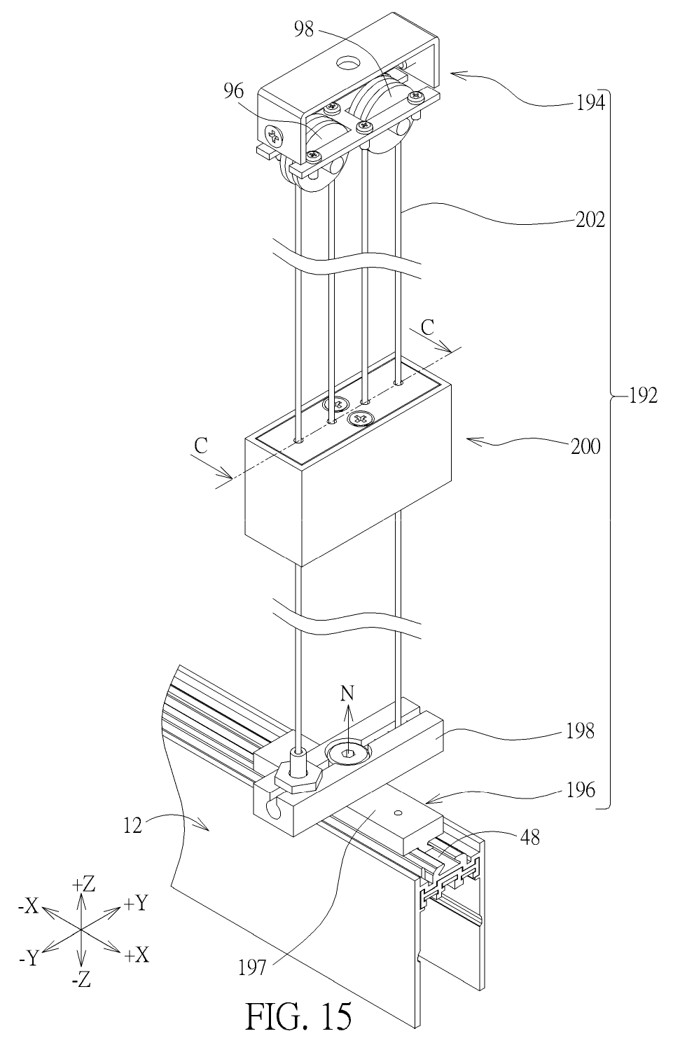

Moreover, the design of the lifting mechanism is also not limited to the aforesaid embodiment. Please refer to FIG. 15, which is an enlarged diagram of a lifting mechanism 192 according to another embodiment of the present invention. Components both mentioned in this embodiment and the aforesaid embodiments represent components with similar structures or functions, and the related description is omitted herein. In this embodiment, as shown in FIG. 15, the lifting mechanism 192 includes a roller device 194, a connection strip 196, a pivot shaft 198, a lifting device 200, and a cable 202. For clearly showing the internal mechanical design of the roller device 194, the housing of the roller device 194 is omitted in FIG. 15. The roller device 194 is disposed above the track 12 rotatably, and has the first roller 96 and the second roller 98. The connection strip 196 is inserted into the second rail structure 48 and is pivoted to the pivot shaft 198. In this embodiment, the pivot shaft 198 is pivoted to the connection strip 196 to be rotatable relative to a normal N of a top surface 197 of the connection strip 196, so that the pivot shaft 198 could be rotatable on the top surface 197 (i.e. a XY plane in FIG. 15). Accordingly, if the track 12 is deviated from the horizontal plane (i.e. the XY plane in FIG. 15), the user could rotate the pivot shaft 198 relative to the connection strip 196 (e.g. as shown in FIG. 15) to make the track 12 positioned horizontally.

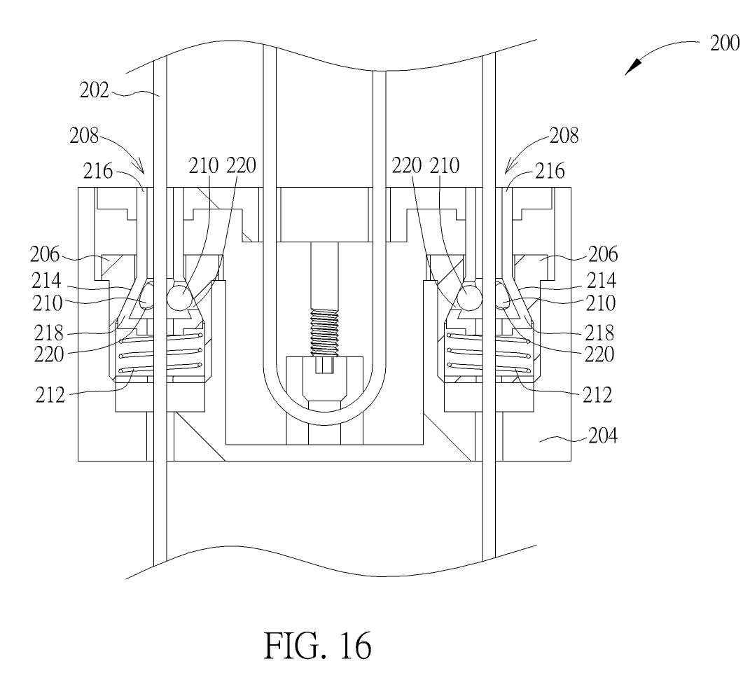

As for the mechanical design of the lifting device 200, it is described in detail as follows. Please refer to FIG. 16, which is a sectional diagram of the lifting device 200 in FIG. 15 along a sectional line C-C. As shown in FIG. 15 and FIG. 16, the lifting device 200 is disposed between the track 12 and the roller device 194 and includes a device body 204, at least one sleeve 206 (two shown in FIG. 16, but not limited thereto), at least one cable fastening member 208 (two shown in FIG. 16, but not limited thereto), at least three balls 210 (only two shown in FIG. 16 due to the sectional viewing angle, but not limited thereto), and an elastic member 212 (e.g. a spring). The sleeve 206 is disposed in the device body 204 and has inner cone surface 214 formed therein. The cable fastening member 208 has a tube portion 216 and a hollow cone portion 218 communicated with the tube portion 216 and is movably disposed in the sleeve 206 to make the tube portion 216 protrude from the sleeve 206 (as shown in FIG. 16). The hollow cone portion 218 has at least three holes 220 (only two shown in FIG. 16 due to the sectional viewing angle, but not limited thereto) formed thereon. The ball 210 is movably disposed in the hole 220. The elastic member 212 abuts against the sleeve 206 and the hollow cone portion 218. The cable 202 is wound on the first roller 96, the device body 204, and the second roller 98 sequentially, and passes through the two cable fastening members 208 and the device body 204 to be connected to two ends of the pivot shaft 198.

Via the aforesaid design, as shown in FIG. 16, the elastic member 212 drives the hollow cone portion 218 to match with the inner cone surface 214 of the sleeve 206, so as to press the balls 210 to clamp the cable 202 cooperatively. Accordingly, the lifting device 200 could be positioned at any position on the cable 202 as desired by clamping of the balls 210, so that the user could adjust the height of the track 12 more conveniently.

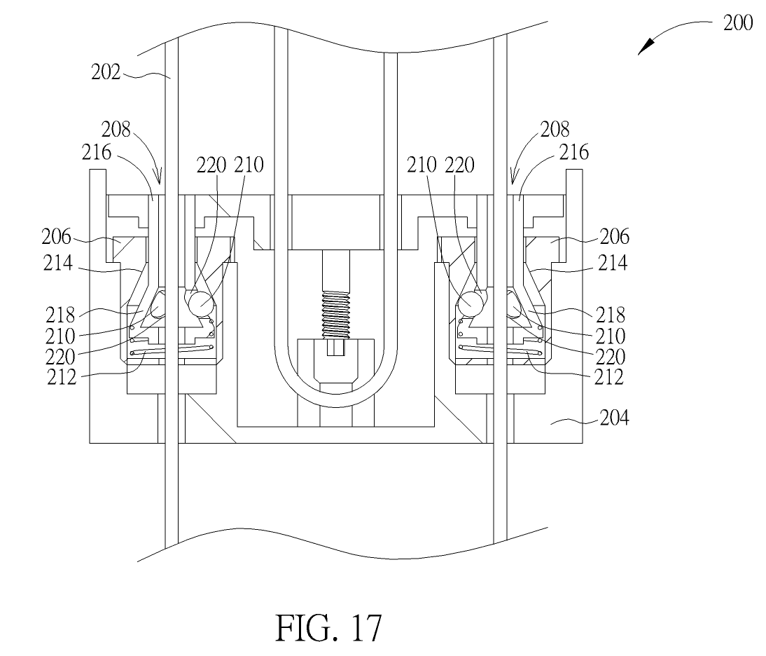

On the other hand, when the user wants to move the lifting device 200 for performing height adjustment of the track 12, the user just needs to press the tube portion 216 (as shown in FIG. 17, which is a sectional diagram of the balls 210 being separate from the cable 202 in FIG. 16), so that the hollow cone portion 218 could be separate from the inner cone surface 214 to make the cable 202 released from clamping of the balls 210. In such a manner, since the cable 202 is no longer clamped by the balls 210, the lifting device 200 could be slidable along the cable 202, so as to allow the user to move the lifting device 200 to any position along the cable 202 as desired for conveniently adjusting the height of the track 12.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A track system comprising:
a track comprising:
a track body having an inner surface and an outer surface opposite to the inner surface;
a first rail structure formed on the inner surface of the track body; and
a second rail structure formed on the outer surface of the track body.

2. The track system of claim 1, wherein the track further comprises an insulation sheet and two electrode sheets, the insulation sheet is inserted into the first rail structure, the insulation sheet has two third rail structures formed spaced, and the two electrode sheets are inserted into the two third rail structures respectively.

3. The track system of claim 1, wherein the track system further comprises an illumination device, the illumination device has at least one telescopic positioning mechanism, the first rail structure has at least one positioning recess formed therein, and the at least one telescopic positioning mechanism is engaged with the at least one positioning recess for detachably fixing the illumination device in the first rail structure when the illumination device is inserted into the first rail structure.

4. The track system of claim 3, wherein a curvature of a first recessed portion of the positioning recess close to the second rail structure is less than a curvature of a second recessed portion of the positioning recess away from the second rail structure.

5. The track system of claim 3, wherein at least one groove is formed on at least one side of the illumination device, and the at least one telescopic positioning mechanism comprises:
a ball disposed in the groove; and
an elastic member abutting against the ball and the groove for driving the ball to be engaged with the positioning recess so as to detachably fix the illumination device to the track.

6. The track system of claim 1, wherein the track further comprises two electrode sheets inserted into the first rail structure, the track system further comprises an illumination device, and the illumination device comprises:
an adapter comprising:
an adapter body; and
two conductive pillars disposed on a top surface of the adapter body corresponding to the two electrode sheets, the two conductive pillars electrically contacting with the two electrode sheets when the adapter body is inserted into the first rail structure; and
an illumination unit disposed under and electrically connected to the adapter.

7. The track system of claim 6, wherein the track further comprises a magnetic sheet, the magnetic sheet is inserted into the first rail structure and is located between the two electrode sheets, and the adapter body further comprises a magnetic block disposed on the top surface of the adapter body for magnetically contacting with the magnetic sheet so as to detachably attach the adapter body to the track.

8. The track system of claim 7, wherein a first step structure is formed on the magnetic block, and a second step structure is formed in the first rail structure for matching with the first step structure so as to guide the magnetic block to magnetically contact with the magnetic sheet.

9. The track system of claim 1, wherein the first rail structure further has a first positioning recess formed therein, the track system further comprises at least one joint, and the at least one joint comprises:
a joint body; and
a first connector detachably connected to a first surface of the joint body, the first connector being engaged with the at least one first positioning recess for detachably fixing the joint to one side end of the track when the first connector is inserted into the first rail structure.

10. The track system of claim 9, wherein the track system further comprises at least one conductive track, the at least one conductive track has at least one second positioning recess formed therein, and the joint further comprises:
two first conductive sheets disposed on the first connector and electrically connected to the joint body;
at least one first telescopic positioning mechanism disposed on at least one side of the first connector, the two first conductive sheets electrically contacting with the track for establishing electrical connection between the joint and the track and the at least one first telescopic positioning mechanism being engaged with the first positioning recess for detachably fixing the joint to one side end of the track when the first connector is inserted into the first rail structure;
at least one second connector electrically connected to the joint body and detachably connected to at least one second surface of the joint body;
two second conductive sheets disposed on the second connector and electrically connected to the joint body; and
at least one second telescopic positioning mechanism disposed on at least one side of the second connector, the two second conductive sheets electrically contacting with the at least one conductive track for establishing electrical connection between the track and the at least one conductive track via the joint and the at least one second telescopic positioning mechanism being engaged with the at least one second positioning recess for detachably fixing the joint to the at least one conductive track when the at least one second connector is inserted into the at least one conductive track.

11. The track system of claim 9, wherein the first connector has two grooves formed thereon, and the joint further comprises:
two conductive sheets inserted into the two grooves respectively; and
two elastic members disposed in the two grooves respectively and abutting against the two conductive sheets respectively, for driving the two conductive sheets to electrically contact with the track when the first connector is inserted into the first rail structure.

12. The track system of claim 1, wherein the track system further comprises an illumination device, the illumination device comprises:
an adapter for electrically contacting with the track body when the adapter is inserted into the first rail structure;
an illumination unit disposed under and electrically connected to the adapter; and
a changeable gear box detachably connected to the adapter and detachably pivoted to the illumination unit; and
a driver disposed in the changeable gear box and electrically connected to the adapter for controlling the illumination unit to emit light.

13. The track system of claim 12, wherein the changeable gear box has at least one first connection surface adjacent to the illumination unit and a second connection surface away from the illumination unit, and the adapter is selectively connected to the at least one first connection surface or the second connection surface.

14. The track system of claim 1 further comprising:
at least one lifting mechanism comprises:
a pivot shaft;
a connection strip pivoted to the pivot shaft and inserted into the second rail structure to make the track rotatable relative to the pivot shaft;
a roller device disposed above the track, the roller device having a first roller and a second roller adjacent to the first roller;
a lifting device disposed between the track and the roller device; and
a cable wound on the first roller, the lifting device, and the second roller sequentially and connected to the two ends of the pivot shaft so as to make the lifting device slidable along the cable for adjusting the height of the track.

15. The track system of claim 14, wherein the lifting device has a third roller and at least one cable clip disposed on the cable, the cable is wound on the first roller, the third roller, and the second roller sequentially, and the at least one cable clip comprises:
a first clip arm having a first clamping portion and a first releasing portion;
a second clip arm having a second clamping portion and a second releasing portion; and
a torsional spring connected between the first clip arm and the second clip arm for driving the first clamping portion and the second clamping portion to clamp the cable cooperatively so as to fix a position of the lifting device relative to the roller device and the track;
wherein when the first releasing portion and the second releasing portion are pressed toward each other, the first clamping portion and the second clamping portion are separate from the cable so as to make the lifting device slidable along the cable.

16. The lifting mechanism of claim 14, wherein the pivot shaft is pivoted to the connection strip to be rotatable relative to a normal of a top surface of the connection strip, the roller device is disposed above the track rotatably, and the lifting device comprises:
a device body;
at least one sleeve disposed in the device body and having inner cone surface formed therein;
at least one cable fastening member having a tube portion and a hollow cone portion communicated with the tube portion, the at least one cable fastening member being movably disposed in the at least one sleeve to make the tube portion protrude from the at least one sleeve, the hollow cone portion having at least three holes formed thereon;
at least three balls movably disposed in the at least three holes; and
an elastic member abutting against the at least one sleeve and the hollow cone portion;
wherein the cable is wound on the first roller, the device body, and the second roller sequentially; the cable passes through the at least one cable fastening member and the device body and is connected to the two ends of the pivot shaft; the elastic member drives the hollow cone portion to match with the inner cone surface so as to press the at least three balls to clamp the cable cooperatively; when the tube portion is pressed, the hollow cone portion is separate from the inner cone surface to make the cable released from the at least three balls, for making the lifting device slidable along the cable for adjusting the height of the track.
